(19) United States
(12) Patent Application Publication
(10) Pub. No.: US 2008/0089577 A1
(43) Pub. Date: Apr. 17, 2008

(54) FEATURE EXTRACTION FROM STEREO IMAGERY

(76) Inventor: Younian Wang, Alpharetta, GA (US)

Correspondence Address: WORKMAN NYDEGGER, 60 E. SOUTH TEMPLE, SUITE 1000, SALT LAKE CITY, UT, 84111, US

(21) Appl. No.: 11/548,628

(22) Filed: Oct. 11, 2006

(51) Int. Cl. G06K 9/00; G06K 9/46; G06K 9/66

(52) U.S. Cl. 382/154; 382/190

(57) ABSTRACT

This application relates to generating a three-dimensional vector object, representing a feature within a scene, by analyzing two-dimensional vector objects representing the feature in a stereo pair. The two-dimensional vector objects are analyzed using stereo vision algorithms to generate the three-dimensional vector object. Results of the analysis derive three-dimensional positions of corresponding points of the two-dimensional vector objects. The three-dimensional vector object is generated based on the results of the stereo vision analysis. The three dimensional vector object can be compared to three-dimensional digital point models. The three dimensional vector object can also be compared to another three-dimensional vector object generated from a stereo pair that are captured under different conditions.

### BACKGROUND

Stereo vision (or stereopsis) is a process for determining the depth or distance of points in a scene based on a change in position of the points in two images of the scene captured from different viewpoints in space. Stereo vision algorithms have been used in many computer based applications to model terrain and objects for vehicle navigation, surveying, and geometric inspection, for example. Computer based stereo vision uses computer processors executing various known stereo vision algorithms to recover a three-dimensional scene from multiple images of the scene taken from different perspectives (referred to hereinafter as a “stereo pair”). As computer processing speeds increase, the applications for computer based stereo vision analysis of imagery also increase.

As processors become faster, analog image processing techniques are increasingly being replaced by digital image processing techniques. Digital image processing techniques are characterized by versatility, reliability, accuracy, and ease of implementation. Digital imagery can be stored in various different formats. Typically, a captured digital image begins as a raster image. A raster image is a data file or structure representing a generally rectangular grid of pixels, or points of color, on a computer monitor, paper, or other display device. Each pixel of the image can be associated with an attribute, such as color. The color of each pixel, for example, can be individually defined. Images in the RGB color space, for instance, often consist of colored pixels defined by three bytes, one byte each for red, green and blue. An image with only black and white pixels requires only a single bit for each pixel. Point cloud models, digital terrain models, and digital elevation models can be likened to pixels including data describing location and elevation attributes of a particular point in the scene.

Computers have also been used to automate much of the analysis required for stereo vision analysis. For example, edge-based methods have been used for establishing correspondence between image points by matching image-intensity patterns along conjugate epipolar lines. Moreover, semi-automated methods have also been implemented where a computer first receives input from a human and then uses this input to establish correspondence between the images in a stereo pair. Thus, computers have become an important tool for generating three-dimensional digital models of scenes in stereo vision.

Another area where digital image processing techniques have become of increased importance is in the area of feature extraction where digital geospatial data, such as raster imagery, is analyzed using various cues to identify features within the geospatial data. Feature extraction includes the use of feature extraction algorithms that use cues to detect and isolate various areas of the geospatial data. These feature extraction algorithms may be used to extract features from the geospatial data, such as roads, railways, and water bodies, for example, that can be displayed on maps or in a Geographic Information System (GIS). A GIS user, a cartographer, or other person can then view the results displayed in the map or a rendered view of the GIS. Currently, however, only two-dimensional feature extractions are conducted, and although several methods and concepts exist for extraction of features from two-dimensional geospatial data, there is still a need for improved feature extraction in three or more dimensions.

### BRIEF SUMMARY OF SEVERAL EMBODIMENTS

A method for generating a three-dimensional vector object is disclosed. In one example, the method includes representing a feature within a scene from a stereo pair of images depicting the scene from different viewpoints. The method further includes establishing corresponding points between a first two-dimensional vector object representing the feature in a first image of the stereo pair and a second two-dimensional vector object representing the feature in a second image of the stereo pair. The method further includes analyzing disparities and similarities between the corresponding points of the first and second two-dimensional objects. The method further includes generating a three-dimensional vector object representing the feature in three-dimensions based on results of the analysis of the disparities and similarities between the first and second two-dimensional vector objects.

These aspects of the present invention will become more fully apparent from the following description and appended claims.

### BRIEF DESCRIPTION OF THE DRAWINGS

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A and 1B illustrate a method of extracting a three dimensional vector object using stereo vision analysis;

FIG. 2A illustrates two cameras acquiring images representing a scene from different viewpoints;

FIG. 2B illustrates two-dimensional vector objects representing a road in vector format in each of a stereo pair;

FIG. 3 illustrates a three-dimensional vector object generated by analyzing the two-dimensional vector objects of FIG. 2B;

FIG. 4 illustrates the three-dimensional vector object of FIG. 3 along with an associated three-dimensional digital point models;

FIG. 5 illustrates a method for generating a three-dimensional vector object from a stereo pair of images; and

FIG. 6 illustrates a suitable computing environment in which several embodiments may be implemented.

### DETAILED DESCRIPTION OF SEVERAL EMBODIMENTS

The present invention relates to extracting three-dimensional feature lines and polygons using stereo imagery analysis. The principles of the embodiments described herein describe the structure and operation of several examples used to illustrate the present invention. It should be understood that the drawings are diagrammatic and schematic representations of such example embodiments and, accordingly, are not limiting of the scope of the present invention, nor are the drawings necessarily drawn to scale. Well-known devices and processes have been excluded so as not to obscure the discussion in details that would be known to one of ordinary skill in the art.

Several embodiments disclosed herein use a combination of manual and automatic processes to produce a fast and accurate tool for at least semi-automated digitization of a three-dimensional model of a scene from a stereo pair. Several embodiments extract three-dimensional features and create a vector layer for a three-dimensional scene from the stereo imagery. Several embodiments also use pattern-recognition processes for extraction of features from a stereo pair to subsequently generate the three-dimensional vector objects. These three-dimensional vector objects can then be associated with the imagery as a three-dimensional vector layer. Various stereo vision algorithms and feature extraction algorithms can be used in different combinations to extract the three-dimensional features, generate three-dimensional vector objects representing the three-dimensional features, associate the three-dimensional vector objects with other geospatial data describing the scene, and/or validate the accuracy of the three-dimensional vector objects as set forth in further detail herein.

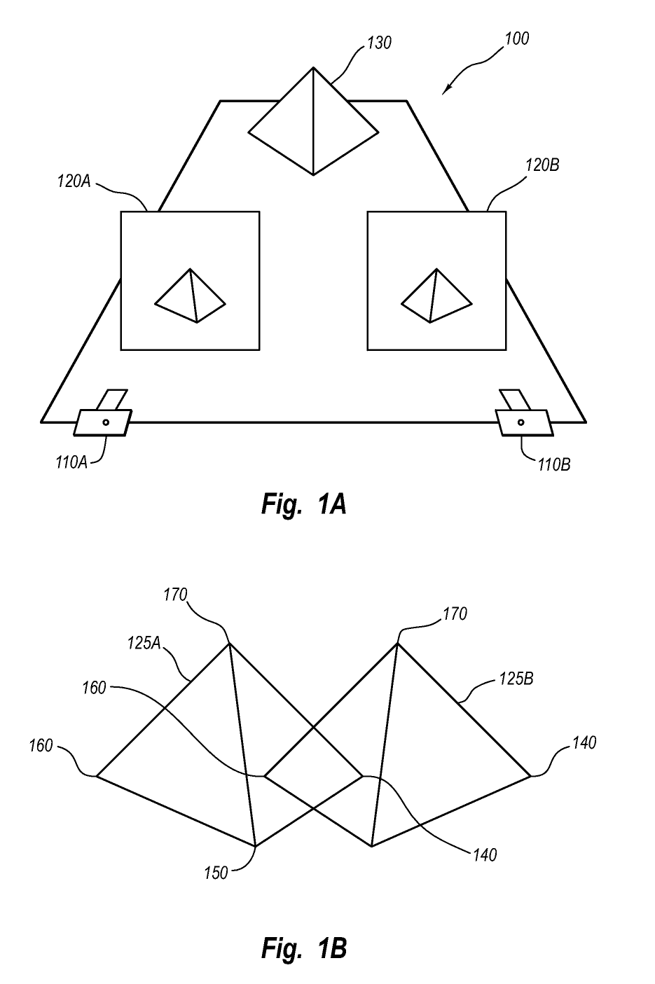

Referring to FIG. 1A, a method of extracting a three dimensional vector object representing a feature within a scene illustrated. A three-dimensional scene 100 is illustrated where two cameras 110A and 110B are acquiring images 120A and 120B of the scene 100 from different viewpoints in space. As illustrated in FIG. 1A, the images 120A and 120B acquired from different viewpoints differ corresponding to the viewpoint from which the image was acquired. These two images 120A and 120B can be compared and analyzed using known stereo vision algorithms to recover information describing the three-dimensional structure of the scene 100. From the results of this analysis a three-dimensional point cloud, digital terrain model, digital elevation model, or other three-dimensional digital models representing the scene (referred to hereinafter collectively as “three-dimensional digital point models”), can be generated. These three-dimensional digital point models can represent topography of the Earth or another surface in digital format, for example by coordinates and numerical descriptions of altitude.

According to an embodiment of the present invention, two-dimensional vector objects can be extracted and analyzed to generate three-dimensional vector objects representing features within the scene 100. For example, a feature 130 is illustrated in the scene 100 of FIG. 1A. The depicted feature 130 is different in the acquired images 120A and 120B depending on the viewpoint from which the images 120A and 120B are acquired. Referring to FIG. 1B, two-dimensional vector objects 125A and 125B have been extracted from the images 120A and 120B respectively. The differences between the feature 130 as depicted in images 120A and 120B are illustrated in an overlaid manner by comparing two-dimensional vector objects 125A and 125B.

A stereo vision analysis algorithm includes a preprocessing step where matching points are associated within each of the two dimensional vector objects 125A and 125B extracted from the stereo pair. This step is often referred to as “correspondence establishment.” For example, in FIG. 1B points 140, 150, 160, and 170 can be established as corresponding points of the vector objects 125A and 125B. The quality of a match can be measured by comparing windows centered at the two locations of the match, for example, using the sum of squared intensity differences (SSD). Many different methods for correspondence establishment, rectification of images, calibration, and recovering three-dimensional digital point models are known in the art and commonly implemented for deriving three-dimensional digital point models from a stereo pair. After correspondence is established, disparities and similarities are analyzed to generate a three-dimensional vector object representing the feature 130 in three dimensions. The three-dimensional vector object can include points, lines, and polygons, for example.

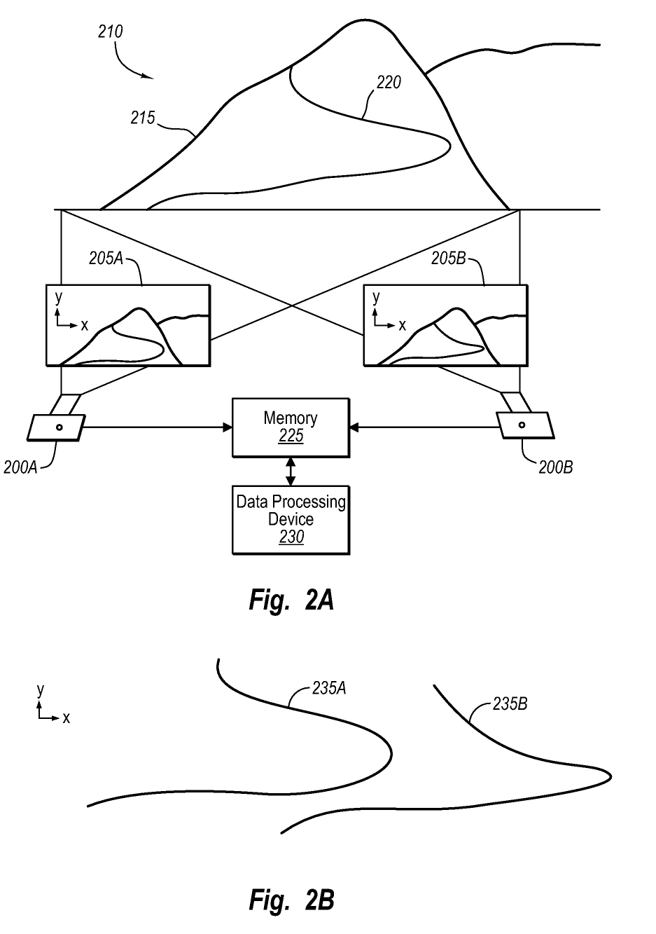

Referring to FIG. 2A, another example method for generating a three-dimensional vector object is illustrated. Two cameras 200A and 200B are shown acquiring images 205A and 205B respectively representing a scene 210 from different viewpoints. The scene 210 can include any surface, object, geography, or any other view capable of image capture. For example, the scene illustrated in FIG. 2A includes a mountain 215 and road 220 features. The mountain 215 and the road 220 are merely examples of geographic objects within a scene. As illustrated, the images 205A and 205B captured by the cameras 200A and 200B are of the same scene 210 from different viewpoints, thus resulting in differences in the relative position of various points of the road 220 for example depicted within the different images 205A and 205B.

The captured images 205A and 205B can be stored in a memory 225 and accessed by a data processing device 230, such as a conventional or special purpose computer. The memory 225 may be, but need not be, shared, local, remote, or otherwise associated with the cameras 200A and 200B or the data processing device 230. The data processing device 230 includes computer executable instructions for accessing and analyzing the images 205A and 205B stored on the memory 225 to extract two-dimensional features from the images 205A and 205B. The extraction of two-dimensional features can be at least semi-automated in that the data processing device 230 can receive inputs from a user, or operate fully autonomously from user input, to identify features within the images 205A and 205B.

For example, the data processing device 230 can receive an input, such as user selection of the road 220, as a cue for identifying pixels within the images 205A and 205B representing the road 220. In this example, in FIG. 2A, the data processing device 230 identifies the road 220 within the different images 205A and 205B and extracts the road 220 as a two-dimensional feature from each image 205A and 205B. The data processing device 230 generates two-dimensional vector objects 235A and 235B representing the road in each of the stereo pair. FIG. 2B illustrates the two-dimensional vector objects 235A and 235B representing the road 220 in vector format extracted from each of the stereo pair 205A and 205B.

The data processing device 230 can collect any two-dimensional geospatial feature from the imagery, such as roads, buildings, water bodies, vegetation, pervious-impervious surfaces, multi-class image classification, and land cover. The data processing device 230 can use multiple spatial attributes (e.g. size, shape, texture, pattern, spatial association and/or shadow), for example, with spectral information to collect geospatial features from the imagery and create vector data representing the features.

In FIG. 2B, a first two-dimensional vector object 235A, and a second two-dimensional vector object 235B, representing the road 220 in each stereo pair 205A and 205B respectively have been generated. For example, the two dimensional vector objects can be vector shapefiles. As shown, the two-dimensional vector objects 235A and 235B differ in relative position and shape due to the different viewpoints from which the images 205A and 205B are acquired.

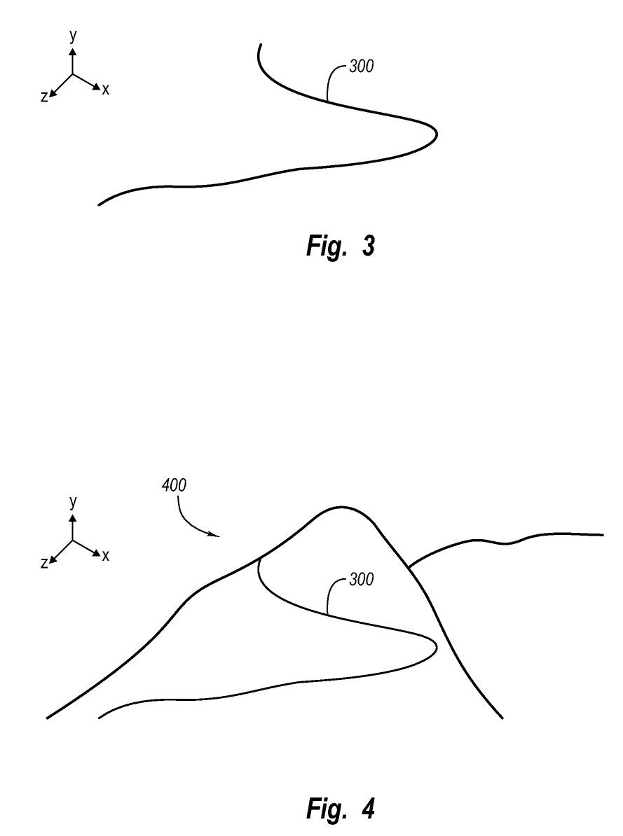

The first and second vector objects 235A and 235B are compared and analyzed, using trigonometric stereo vision and image matching algorithms, to derive position attributes describing the road 220 in the scene 210. From the relative position attributes, a three-dimensional vector object 300 is generated as illustrated in FIG. 3. This three-dimensional vector object 300 represents the road 220 in three-dimensions in the vector domain. The first two-dimensional vector object 235 A and the second two-dimensional vector object 235 B need not both represent the entire road 220, however. For example, if a first two-dimensional vector object only represented a portion of the road 220 of which a second two-dimensional vector object represents, three-dimensional information may still be gathered describing the portion of the road 220 represented by both of the first and second two-dimensional vector objects. For example, a three dimensional vector object can be generated representing the portion of the road represented by both the first and second two dimensional vector objects. Thus, the entire feature, in this instance the road 220, need not have the same start and end points in each of the stereo pair in order to derive three dimensional information or three dimensional vector objects describing the feature.

Various other geospatial data can be generated by analyzing the stereo pair 205A and 205B. For example, three-dimensional digital point models can be generated describing the scene 210 in three-dimensions using conventional stereo imagery analysis. The three-dimensional vector object 300 representing the road 220 can be associated as a vector layer with three-dimensional point models 400 as illustrated in FIG. 4.

The three-dimensional point models 400 can also be compared to the three-dimensional vector object 300 to confirm the accuracy of the three-dimensional vector object 300 and/or to confirm the accuracy of the three-dimensional point model 400. For example, a digital terrain model generated by analyzing a stereo pair can be compared to a three-dimensional vector object generated by analyzing the same stereo pair. The comparison of the digital terrain model to the three-dimensional vector object can be used to check the accuracy of the three-dimensional vector object and/or the digital terrain model.

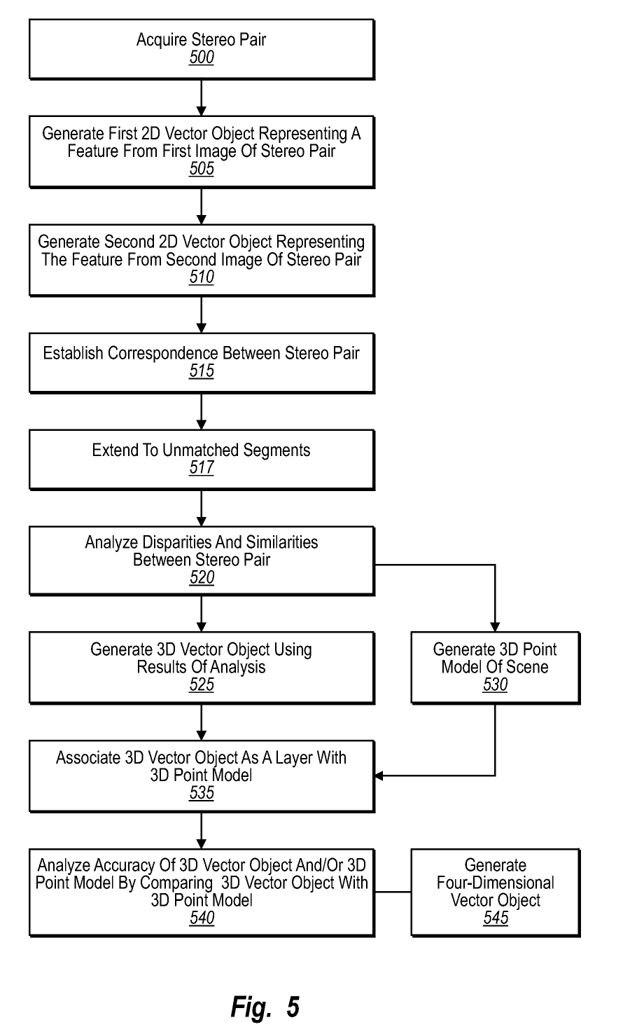

Referring to FIG. 5, an example of a method for generating a three-dimensional vector object from a stereo pair of images is illustrated. The stereo pair is acquired (500). The stereo pair can be acquired by a pair of cameras or the same camera from two different view points in the field, for example. The stereo pair can depict geography including a feature from different viewpoints. The stereo pair can be digital images or analog images later converted to a digital format and can be stored in a computer readable medium, transmitted over a communications connection, or otherwise retained for analysis.

A first two-dimensional vector object is generated by extracting the feature from a first image of the stereo pair (505). The first two-dimensional vector object can be generated in an at least semi-autonomous manner. For example, using feature extraction software, such as Feature Analyst for ERDAS IMAGINE by Leica Geosystems, the feature can be extracted using only limited input received by a user in this example. A user can select pixels representative of the feature in the first image of the stereo pair and the feature extraction software can use the representative pixels to identify the feature in the first image of the stereo pair. Once the pixels of the feature are identified, the two-dimensional vector object can be generated as a vector file including lines and polygons representing the feature in the vector domain.

A second two-dimensional vector object is generated in a similar manner to the first two-dimensional vector object by extracting the feature from a second image of the stereo pair (510). The feature is extracted and the second two-dimensional vector object can be generated in an at least semi-autonomous manner using software.

Correspondence between the stereo pair is established (515). Correspondence can be established in a manual, semi-autonomous, or automated manner. For example, a user can select at least one corresponding point on each of the two-dimensional vector objects (e.g. see FIG. 1B). Based on the corresponding point(s) selected by the user, software can identify additional corresponding points on the vector objects derived from the stereo pair.

Features that may be only partially represented in the stereo pair can be extended (517). For example, a feature may be partially represented in each image of the stereo pair, but not all of the feature is so represented. A feature such as a road may appear in each image of the stereo pair and also in only one image as it extends out of one image into another. Once the stereo pair are matched using the overlapping portion, the match can be extrapolated and used to describe the road in three dimensions even though the road cannot be visualized in stereo. Thus, the invention can be applied to describing features in three dimensions using stereo pairs, even when the features cannot be visualized in the stereo imagery because the features are represented or partially represented in only one image. As described above, the features may not have the same start and end points in each of the stereo pair of images and the teachings herein may still be implemented to gather information describing the feature in three dimensions for the portions of the feature that are represented in both images of the stereo pair. Moreover, interpolation or extrapolation algorithms may be used to extend the feature within an image where applicable.

Disparities and similarities between the points of correspondence are analyzed (520) using trigonometric stereo vision and image matching algorithms to determine three-dimensional position and elevation of various points of the feature represented by the pair of two-dimensional vector objects.

By analyzing the two-dimensional vector objects using stereo vision algorithms, the feature is extracted in three-dimensions. A three-dimensional vector object is generated (525) and the three-dimensional vector object can be stored in memory, saved as a vector layer associated with the feature and/or scene, or otherwise utilized.

A three-dimensional digital point model, such as a point cloud, digital terrain model or digital elevation model, can also be generated (530) using stereo imagery analysis of disparities and similarities between the stereo pair of images. The three-dimensional digital point model can be associated with the three-dimensional vector object (535). The three-dimensional digital point model can also be compared to the three-dimensional vector object to identify any disparities and similarities between the two. The disparities and similarities can be analyzed to determine the accuracy of the three-dimensional digital model and/or the three-dimensional vector object representing the feature (540). For example, certain discontinuities in the images of the stereo pair, such as shadows, interference from other features, and changes in light conditions, may introduce error in one of the three-dimensional digital model or the three-dimensional vector object. In this instance, comparison of the two can identify such errors.

A four-dimensional vector object can also be generated (545). The four-dimensional vector object can be generated by first generating a first three-dimensional vector object representing a feature at a first point in time and comparing the first three-dimensional vector object to a second three-dimensional vector object representing the same feature but generated at a second point in time that is later in time than the first point in time. Thus, the four-dimensional vector object can illustrate three-dimensional changes to the feature over time.

Three-dimensional vector objects generated from different stereo pairs captured under different conditions, such as captured at different times, from different locations, using different equipment, and under other changes in conditions can also be compared to determine accuracy of the three-dimensional vector objects. For example, a first stereo pair may be acquired under a first set of conditions, such as lighting conditions, time of day, by different equipment, angle of sunlight, etc. A second stereo pair can be acquired under a different set of conditions. Three-dimensional vector objects generated from the different stereo pairs can be compared to determine whether errors exist in the three-dimensional vector objects.

As discussed above, analysis of the stereo pair can be carried out using stereo vision algorithms executed by a data processor. The data processor can be part of a conventional or special purpose computer system. Embodiments within the scope of embodiments illustrated herein can also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

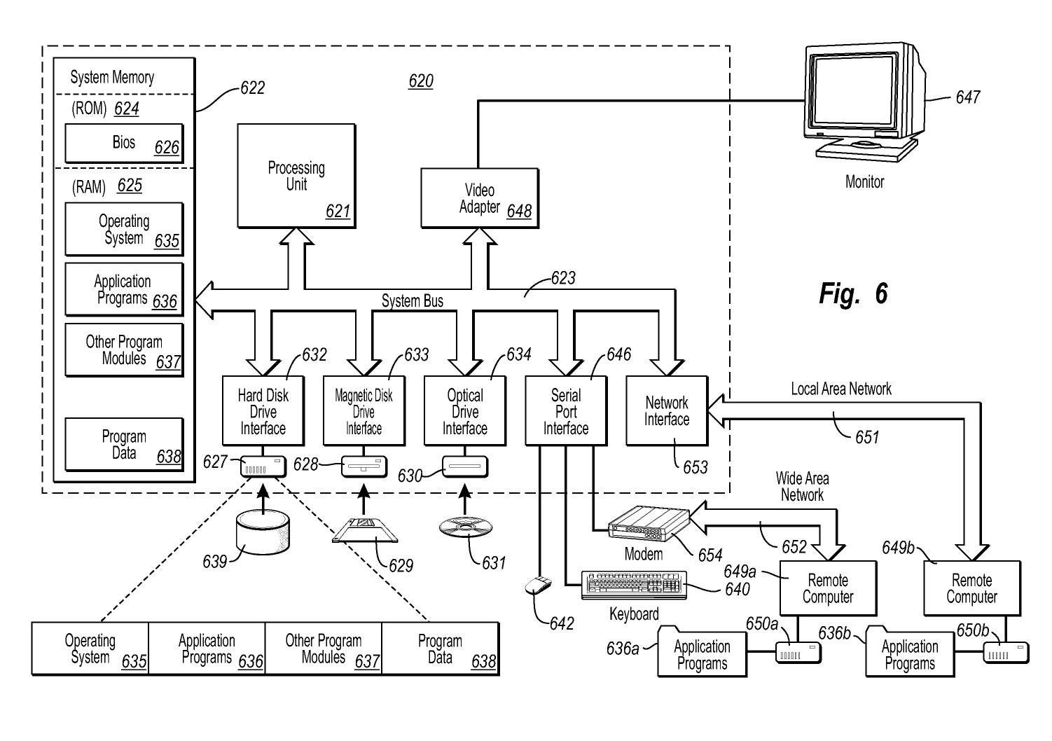

FIG. 6 and the following discussion are intended to provide a brief, general description of a suitable computing environment in which several embodiments may be implemented. Although not required, several embodiments will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those skilled in the art will appreciate that the embodiments disclosed herein may be practiced in network computing environments with many types of computer system configurations, including personal computers, hand-held devices, multi-processor systems, microprocessor-based or programmable consumer electronics, network PCs, minicomputers, mainframe computers, and the like. Several embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 6, an exemplary system for implementing several embodiments includes a general purpose computing device in the form of a conventional computer 620, including a processing unit 621, a system memory 622, and a system bus 623 that couples various system components including the system memory 622 to the processing unit 621. The system bus 623 may be any of several types of bus structures including a memory bus or memory controller, a peripheral bus, and a local bus using any of a variety of bus architectures. The system memory includes read only memory (ROM) 624 and random access memory (RAM) 625. A basic input/output system (BIOS) 626, containing the basic routines that help transfer information between elements within the computer 620, such as during start-up, may be stored in ROM 624.

The computer 620 may also include a magnetic hard disk drive 627 for reading from and writing to a magnetic hard disk 639, a magnetic disk drive 628 for reading from or writing to a removable magnetic disk 629, and an optical disk drive 630 for reading from or writing to removable optical disk 631 such as a CD ROM or other optical media. The magnetic hard disk drive 627, magnetic disk drive 628, and optical disk drive 630 are connected to the system bus 623 by a hard disk drive interface 632, a magnetic disk drive-interface 633, and an optical drive interface 634, respectively. The drives and their associated computer-readable media provide nonvolatile storage of computer-executable instructions, data structures, program modules and other data for the computer 620. Although the exemplary environment described herein employs a magnetic hard disk 639, a removable magnetic disk 629 and a removable optical disk 631, other types of computer readable media for storing data can be used, including magnetic cassettes, flash memory cards, digital versatile disks, Bernoulli cartridges, RAMs, ROMs, and the like.

Program code means comprising one or more program modules may be stored on the hard disk 639, magnetic disk 629, optical disk 631, ROM 624 or RAM 625, including an operating system 635, one or more application programs 636, other program modules 637, and program data 638. A user may enter commands and information into the computer 620 through keyboard 640, pointing device 642, or other input devices (not shown), such as a microphone, joy stick, game pad, satellite dish, scanner, or the like. These and other input devices are often connected to the processing unit 621 through a serial port interface 646 coupled to system bus 623. Alternatively, the input devices may be connected by other interfaces, such as a parallel port, a game port or a universal serial bus (USB). A monitor 647 or another display device is also connected to system bus 623 via an interface, such as video adapter 648. In addition to the monitor, personal computers typically include other peripheral output devices (not shown), such as speakers and printers.

The computer 620 may operate in a networked environment using logical connections to one or more remote computers, such as remote computers 649a and 649b. Remote computers 649a and 649b may each be another personal computer, a server, a router, a network PC, a peer device or other common network node, and typically include many or all of the elements described above relative to the computer 620, although only memory storage devices 650a and 650b and their associated application programs 636a and 636b have been illustrated in FIG. 6. The logical connections depicted in FIG. 6 include a local area network (LAN) 651 and a wide area network (WAN) 652 that are presented here by way of example and not limitation. Such networking environments are commonplace in office-wide or enterprise-wide computer networks, intranets and the Internet.

When used in a LAN networking environment, the computer 620 is connected to the local network 651 through a network interface or adapter 653. When used in a WAN networking environment, the computer 620 may include a modem 654, a wireless link, or other means for establishing communications over the wide area network 652, such as the Internet. The modem 654, which may be internal or external, is connected to the system bus 623 via the serial port interface 646. In a networked environment, program modules depicted relative to the computer 620, or portions thereof, may be stored in the remote memory storage device. It will be appreciated that the network connections shown are exemplary and other means of establishing communications over wide area network 652 for analyzing a stereo pair of images can be used.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for generating a three-dimensional vector object representing a feature within a scene from a stereo pair of images depicting the scene from different viewpoints, the method comprising:
establishing correspondence between a first two-dimensional vector object and a second two-dimensional vector object, the first two-dimensional vector object representing the feature in a first image of the stereo pair and the second two-dimensional vector object representing the feature in a second image of the stereo pair;
analyzing disparities and similarities between the first and second two-dimensional objects; and
generating a three-dimensional vector object representing the feature in three-dimensions based on results of the analysis of the disparities and similarities between the first and second two-dimensional vector objects.

2. A method according to claim 1, wherein the disparities and similarities between the two-dimensional features are analyzed using a stereo vision triangulation and/or image matching algorithm.

3. A method according to claim 1, wherein the analysis of the disparities and similarities comprises deriving three-dimensional elevation and/or position data describing corresponding points of the stereo pair.

4. A method according to claim 1, further comprising capturing the stereo pair of images from different viewpoints.

5. A method according to claim 1, wherein establishing correspondence between the first two-dimensional vector object and the second two-dimensional vector object includes receiving a manual input identifying at least two corresponding points of the feature in each of the two-dimensional vector objects.

6. A method according to claim 5, wherein the two-dimensional vector objects are generated by a semi-automated process where additional corresponding points are identified by a machine.

7. A method according to claim 1, further comprising:
generating the first two-dimensional vector object by analyzing the first image of the stereo pair; and
generating the second two-dimensional vector object by analyzing the second image of the stereo pair.

8. A method according to claim 7, wherein generating the first and second two-dimensional vector objects includes receiving a manual input identifying representative pixels in the stereo pair that represent the feature.

9. A method according to claim 8, wherein additional pixels representing the feature in the stereo pair are identified by a machine based on the representative pixels.

10. A method according to claim 1, wherein the two-dimensional vector objects are two-dimensional shapefiles.

11. A method according to claim 1, further comprising generating a three-dimensional digital point model using stereo vision analysis of the stereo pair.

12. A method according to claim 11, further comprising comparing the three-dimensional digital point model to the three-dimensional vector object to identify disparities and similarities between the three-dimensional digital point model and the three-dimensional vector object.

13. A method according to claim 12, further comprising modifying the three-dimensional vector object representing the feature based on the disparities and similarities identified.

14. A method according to claim 1, further comprising comparing the first and second two-dimensional vector objects to identify a portion of one of the first or second two-dimensional vector objects only partially represented in one of the stereo pair of images; and modifying one of the first or second two-dimensional vector objects based on the portion identified of the one of the first or second two dimensional vector objects only partially represented in one of the stereo pair of images.

15. A method according to claim 1, further comprising:
analyzing a first stereo pair by performing the method of claim 1 to generate a first three-dimensional vector object representing the feature; and
analyzing a second stereo pair by performing the method of claim 1 to generate a second three-dimensional vector object representing the feature, wherein the second stereo pair is acquired under different conditions than the first stereo pair.

16. A method according to claim 15, further comprising:
comparing the first and second three-dimensional vector objects to identify disparities and similarities between the first and second three-dimensional vector objects.

17. A method according to claim 16, wherein the first and second stereo pairs are acquired under different light conditions, and wherein analysis of the disparities and similarities between the first and second stereo pairs identify errors in one of the three-dimensional vector objects introduced by a shadow in one of the images of the stereo pairs.

18. A method for generating a four-dimensional vector object for a feature within a scene from a stereo pair of images, the method comprising:
performing the method of claim 1 at a first point in time to generate a first three-dimensional vector object;
performing the method of claim 1 at a second point in time later than the first point of time to generate a second three-dimensional vector object;
comparing the first and second three-dimensional vector objects to identify disparities and similarities between the first and second three-dimensional vector objects; and
generating a four-dimensional vector object based on results of the comparison of the first and second three-dimensional vector objects.

19. A computer-readable medium having computer executable instructions that are configured to cause a data processing device to perform the following acts:
establishing correspondence between a first two-dimensional vector object and a second two-dimensional vector object, the first two-dimensional vector object representing the feature in a first image of the stereo pair and the second two-dimensional vector object representing the feature in a second image of the stereo pair;
analyzing disparities and similarities between the first and second two-dimensional objects; and
generating a three-dimensional vector object representing the feature in three-dimensions based on results of the analysis of the disparities and similarities between the first and second two-dimensional vector objects.

20. A data processing device comprising:
the computer-readable medium of claim 19; and
a data processor.

21. A three-dimensional vector object stored as a data structure in a computer readable medium, the three-dimensional vector object being generated by analyzing a stereo pair of images according to the following acts:
establishing correspondence between a first two-dimensional vector object and a second two-dimensional vector object, the first two-dimensional vector object representing the feature in a first image of the stereo pair and the second two-dimensional vector object representing the feature in a second image of the stereo pair;
analyzing disparities and similarities between the first and second two-dimensional objects; and
generating a three-dimensional vector object representing the feature in three-dimensions based on results of the analysis of the disparities and similarities between the first and second two-dimensional vector objects.
